(19) United States
(12) Patent Application Publication
(10) Pub. No.: US 2003/0051655 A1
(43) Pub. Date: Mar. 20, 2003

(54) Cleanout alert

(76) Inventor: Ray Broyles, Springfield, MO (US)

Correspondence Address: RAY BROYLES, 2365 S. McCANN, SPRINGFIELD, MO, 65804, US

(21) Appl. No.: 10/078,103

(22) Filed: Feb. 19, 2002

Related U.S. Application Data
(60) Provisional application No. 60/322,605, filed on Sep. 17, 2001.

(51) Int. Cl. G01F 1/00

(52) U.S. Cl. 116/110

(57) ABSTRACT

Now, most home and business water/sewer pipes are fitted with a four inch diameter PVC pipe running from the confluence of the subsidiary house outlet pipes and the main home sewer pipe to the surface. This pipe is fitted on top with a screw-in top cap. A hole is drilled into the center of this top cap and the cleanout alert inserted into the cap with the rod running thru the cap-the float is adjusted to set at the confluence of the outlet pipes and the main house sewer pipe. A finial is attached to the top of the rod on top of the screw-in top cap. Any cloggage/stoppage evident at the sub-surface level (evidenced by a movement of the finial above the surface) alerts the tenant to the fact, preventing damaging consequences if the situation is not corrected. There are not now any sub-surface warning devices of this type alerting the tenant, very early, that a cloggage is occurring and preventing a damaging sewage back-up.

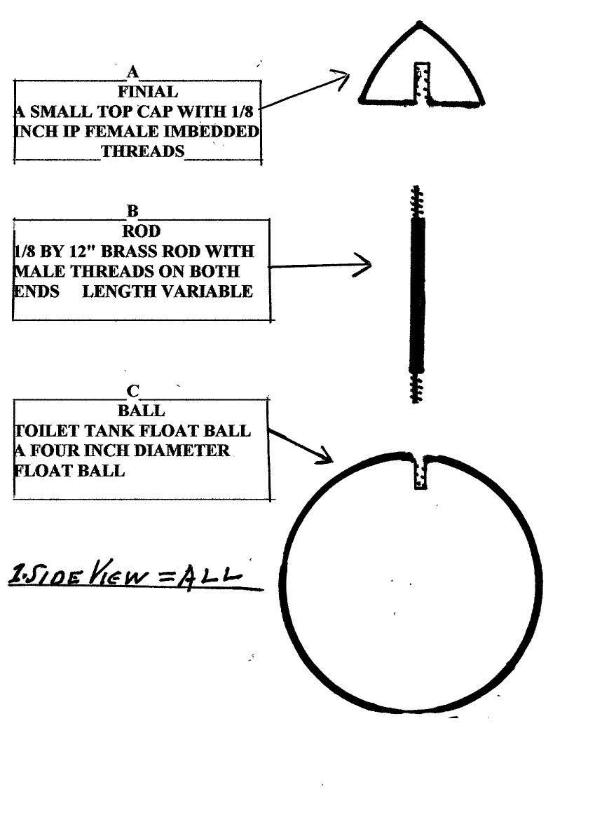

### REFERENCE-PROVISIONAL PATENT

Serial No. 60/322,60-filed Sep. 17, 2001.

Confirmation Number-6006

### NO FEDERAL SPONSORSHIP

### NO CORPORATION SPONSORSHIP

### BACKGROUND

### FIELD-PLUMBING

To prevent sewage from backing up into the yard or house (the sinks, bathtub, carpets, floor, etc.) a warning is needed to alert the houseowner of the fact of a cloggage (or the beginning of a cloggage) is occurring in the sewer line.

### DESCRIPTION:

### THE CLEANOUT ALERT CONSISTS OF THREE ITEMS

A . . . A finial-a small top cap with ⅛ inch IP female imbedded threads

B . . . A rod-a ⅛ by 12 inch brass rod with male threads on both ends, length variable by use of longer rod or connecting a second rod to the first by use of a coupler.

C . . . A ball-a four inch diameter float ball with imbedded female threads-a toilet tank float ball.

### CONSTRUCTION OF THE CLEANOUT ALERT

A-finial, which comprises the top of the cleanout alert is screwed onto the top of the rod B.

C-ball, which comprises the bottom of the cleanout alert is screwed onto the other end of the rod B.

USAGE:

A 5/16 inch hole is drilled into the center of the PVC cleanout outlet cap-the rod (B) is placed through this hole with the finial (A) on top of the cap and the ball (C) on the bottom.

The cleanout alert is inserted vertically into the four inch PVC cleanout pipe and the cleanout outlet cap is screwed back onto the cleanout pipe.

This places the ball just above the juncture of the main sewer pipe and the subsidiary pipes leading to the stools, sinks, showere, etc.

Since the cleanout alert ball is unfettered, any rise in the sewage level near the juncture results in action of the top finial and alerts the homeowner that there is a potential problem.

This alert could make the homeowner aware of a potential proble days or weeks before the problem would be evident on the surface (since the cleanout would be evident on the suface (since the cleanout alert is sub-surface).

1. I claim that I am the inventor of this novel and innovative device.

2. I claim there is no other deep sub-surface device for detecting the clogging or stoppage of a household sewer line.

3. I claim this is a very useful device since many thousands and probably more, homes have PVC cleanout outlets with no early sub-surface warning of a sewer cloggage or stoppage.

4. This device gives the homeowner time to have the sewer pipe cleaned out before going thru the stress and strain of repairing the damage caused by back-up of sewage into the home
